(19) United States
(12) Patent Application Publication
(10) Pub. No.: US 2019/0237772 A1
(43) Pub. Date: Aug. 1, 2019

(54) ELECTRODE MATERIAL AND METHOD FOR PRODUCING SAME

(71) Applicant: SAKAI CHEMICAL INDUSTRY CO., LTD., Sakai-shi, Osaka (JP)

(72) Inventors: Keiichi TABATA, Osaka (JP); Seiichi YANO, Osaka (JP); Hiroshi TSUTSUMI, Osaka (JP); Jun NAITO, Osaka (JP); Mayu OTA, Osaka (JP); Miho KISHI, Osaka (JP)

(21) Appl. No.: 16/340,959

(22) PCT Filed: Oct. 19, 2017
(86) PCT No.: PCT/JP2017/037836

§ 371 Date: Apr. 10, 2019

(30) Foreign Application Priority Data
Nov. 22, 2016 (JP) 2016-226903

(51) Int. Cl. H01M 4/92

(52) U.S. Cl. CPC H01M 4/925; H01M 2008/1095

(57) ABSTRACT

The present invention provides an electrode material having excellent resistance to a high potential and strongly acidic environment, high conductivity, and excellent electrochemical properties; and a fuel cell including the same. The present invention also provides a method for simply and easily producing such an electrode material. The present invention relates to an electrode material containing: a titanium suboxide carrier whose crystal phase is single-phase Ti₄O₇ and having a specific surface area of 10 m²/g or more; and a noble metal and/or its oxide supported on the carrier.

### TECHNICAL FIELD

The present invention relates to an electrode material and a method for producing the same.

### BACKGROUND ART

Fuel cells are devices that generate electric power by electrochemically reacting fuel such as hydrogen or alcohol with oxygen, and are classified into different types such as polymer electrolyte fuel cells (PEFCs), phosphoric acid fuel cells (PAFCs), molten-carbonate fuel cells (MCFCs), and solid oxide fuel cells (SOFCs), according to factors such as electrolyte and operating temperature. Among these, polymer electrolyte fuel cells, for example, are fuel cells that use a polymer membrane (ion exchange membrane) having ion conductivity as an electrolyte. Such fuel cells are used as stationary power sources or for fuel cell vehicles, and are expected to maintain desired power generation performance for a long period of time.

Such fuel cells include an electrode material that contains carbon having high conductivity (also referred to as electrical conductivity) as a carrier and platinum nanoparticles supported on the carrier, and the electrode material has excellent electrochemical properties. The fuel cells are thus commonly used (see Patent Literature 1). In recent years, various electrode materials having different forms from the above have been studied (for example, see Patent Literatures 2 and 3).

### CITATION LIST

### Patent Literature

### Patent Literature 1: JP 2012-17490 A

### Patent Literature 2: WO 2011/065471

### Patent Literature 3: JP 2004-363056 A

### SUMMARY OF INVENTION

### Technical Problem

As described above, electrode materials containing platinum supported on a carbon carrier (hereinafter also referred to as “Pt/C”) are commonly used (see Patent Literature 1). Usually, use of an electrode material at high potential is advantageous because the number of stacked electrodes is reduced. Yet, such use at high potential may cause oxidation reaction of a carbon carrier (C+2H₂O→CO₂+4H⁺+4e⁻) to proceed. For example, when the potential of the electrode is higher than 0.9 V, the oxidation reaction of the carbon carrier carrying platinum easily proceeds. In this case, aggregation or detachment of the supported platinum occurs, and the effective electrode area is reduced, thus significantly reducing the fuel cell performance (see Patent Literatures 2 and 3). In particular, in automotive applications which require electrodes capable of withstanding large load fluctuations due to operations such as start and stop, a control device that controls the electrode potential to be lower than 0.9 V is separately provided as a current measure against such fluctuations. In addition, generally, environments in which electrodes are used are strongly acidic with a pH of 1 or less, so that electrode materials are required to have resistance to strongly acidic environments.

Patent Literature 2 discloses an electrode catalyst in which a noble metal and/or an alloy containing noble metal is supported on an electrode catalyst carrier that is an aggregate of primary particles of a metal oxide. Titanium oxide is disclosed as a metal oxide. Unfortunately, titanium oxide (TiO₂) has insufficient conductivity. Patent Literature 2 also describes doping titanium oxide with niobium to impart conductivity. Yet, this requires care regarding the possibility of dissolution of the dopant out of particles and the influence of the dopant on power generation characteristics of a fuel cell.

Meanwhile, titanium suboxide having a Magneli-phase structure represented by TiₙO₂ₙ₋₁ (n>4) is known as an oxide that exhibits conductivity without containing a metal element dopant. In particular, Ti₄O₇ is known to have high conductivity comparable to that of carbon. However, since Ti₄O₇ is synthesized by reducing (deoxidizing) raw material titanium oxide (TiO₂) at high temperatures (900° C. or higher), conventionally obtained single-phase Ti₄O₇ has a small specific surface area (about 1 m²/g) due to progress of sintering by high-temperature heat treatment.

Meanwhile, imparting excellent electrochemical properties to an electrode material requires allowing as many noble metal microparticles (such as platinum) as possible to be independently supported on carrier particles. Thus, in order for Ti₄O₇ to be used as a carrier instead of carbon, each Ti₄O₇ particle should be able to uniformly carry platinum nanoparticles as in Pt/C. Yet, it is very difficult for conventional Ti₄O₇ particles having a specific surface area of about 1 m²/g to carry platinum nanoparticles in an amount equivalent to that can be supported by Pt/C. For example, in a commonly used method in which a solution containing platinum nanoparticles is added to Ti₄O₇ particles and evaporated to dryness, the platinum particles are supported in an aggregated state or a coarse state, thus failing to achieve electrochemical properties equivalent to those of Pt/C. As described above, no electrode material has been provided which is capable of exerting high conductivity without using carbon and having excellent electrochemical properties and resistance to a high potential and strongly acidic environment.

In view of the current state, the present invention aims to provide an electrode material having excellent resistance to a high potential and strongly acidic environment, high conductivity, and excellent electrochemical properties; and a fuel cell including the same. The present invention also aims to provide a method for simply and easily producing such an electrode material.

### Solution to Problem

The present inventors conducted intensive studies on titanium suboxide, particularly Ti₄O₇, as a carrier alternative to carbon of electrode materials, with a focus on its high resistance to a high potential and strongly acidic environment and its high conductivity. They found that when an electrode material has a structure in which a single-phase Ti₄O₇ having a large specific surface area is used as a carrier and a noble metal and/or its oxide is supported on the carrier, the electrode material has high conductivity and excellent electrochemical properties even in a high potential and strongly acidic environment. The present inventors also found that such an electrode material can be simply and easily produced by a production method including: step (1) of obtaining a titanium suboxide carrier having a specific surface area of 10 m²/g or more; and step (2) of allowing a noble metal and/or its oxide to be supported on the carrier using a mixture containing the titanium suboxide carrier and the noble metal and/or its water-soluble compound. Thus, the present inventors arrived at solutions to the above problems, and have thus completed the present invention. The term “titanium oxide” used herein refers to titanium oxide (also referred to as “titanium dioxide”) available on regular market, and specifically refers to what is called “TiO₂” in qualitative tests such as X-ray diffraction measurement.

Specifically, the present invention relates to an electrode material containing: a titanium suboxide carrier whose crystal phase is single-phase Ti₄O₇ and having a specific surface area of 10 m²/g or more; and a noble metal and/or its oxide supported on the carrier.

The noble metal is preferably at least one metal selected from the group consisting of platinum, ruthenium, iridium, rhodium, and palladium, and has an average primary particle size of 1 to 20 nm. The noble metal is more preferably platinum.

The electrode material is preferably an electrode material of a polymer electrolyte fuel cell.

The present invention also relates to a fuel cell including an electrode including the electrode material described above.

The present invention further relates to a method for producing the electrode material. The production method includes: step (1) of obtaining a titanium suboxide carrier whose crystal phase is single-phase Ti₄O₇ and having a specific surface area of 10 m²/g or more; and step (2) of allowing a noble metal and/or its oxide to be supported on the carrier using a mixture containing the titanium suboxide carrier obtained in step (1) and the noble metal and/or its water-soluble compound.

Step (1) is preferably a step of firing a dry mixture containing rutile type titanium oxide having a specific surface area of 20 m²/g or more and titanium metal and/or titanium hydride under a hydrogen atmosphere.

### Advantageous Effects of Invention

The electrode material of the present invention has excellent resistance to a high potential and strongly acidic environment, high conductivity equal to or higher than that of a conventional material containing platinum supported on a carbon carrier, and excellent electrochemical properties. Thus, the electrode material is useful as an electrode material of fuel cells such as polymer electrolyte fuel cells, solar cells, transistors, and display devices such as liquid crystal display panels. In particular, the electrode material is very useful for polymer electrolyte fuel cells. The production method of the present invention can simply and easily produce such an electrode material, and is thus considered to be an industrially very useful technique.

### BRIEF DESCRIPTION OF DRAWINGS

FIG. 1-1 is an X-ray powder diffraction pattern of a powder obtained in Example 1.

FIG. 1-2 is an image of the powder obtained in Example 1, taken by a transmission electron microscope (abbreviated as TEM).

FIG. 2-1 is an X-ray powder diffraction pattern of a powder obtained in Example 2.

FIG. 2-2 is a TEM image of the powder obtained in Example 2.

FIG. 3-1 is an X-ray powder diffraction pattern of a powder obtained in Comparative Example 1.

FIG. 3-2 is a TEM image of the powder obtained in Comparative Example 1.

FIG. 4-1 is an X-ray powder diffraction pattern of a powder obtained in Comparative Example 2.

FIG. 4-2 is a TEM image of the powder obtained in Comparative Example 2.

FIG. 5-1 is an X-ray powder diffraction pattern of a powder obtained in Comparative Example 3.

FIG. 5-2 is a TEM image of the powder obtained in Comparative Example 3.

FIG. 6-1 is an X-ray powder diffraction pattern of a powder obtained in Comparative Example 4.

FIG. 6-2 is a TEM image of the powder obtained in Comparative Example 4.

FIG. 7-1 is an X-ray powder diffraction pattern of a powder obtained in Comparative Example 5.

FIG. 7-2 is a TEM image of the powder obtained in Comparative Example 5.

FIG. 8 is a diagram explaining XRD data analysis to identify the crystal phase.

### DESCRIPTION OF EMBODIMENTS

Preferred embodiments of the present invention are specifically described below, but the present invention is not limited to the following description, and modification may be suitably made without departing from the gist of the present invention.

### 1. Electrode Material

The electrode material of the present invention contains a titanium suboxide carrier and a noble metal and/or its oxide supported thereon.

The crystal phase of the titanium suboxide carrier is single-phase Ti₄O₇.

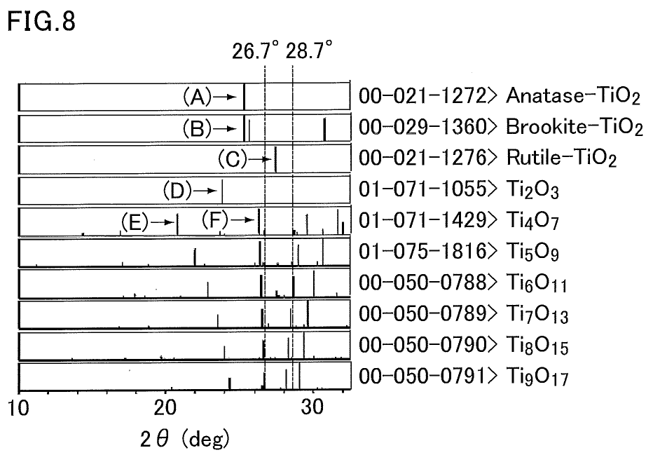

Herein, the electrode material “whose crystal phase is single-phase Ti₄O₇” is an electrode material in which Ti₄O₇ is present but no other titanium oxides are present in an X-ray diffraction (XRD) measurement pattern measured in a state where a noble metal and/or its oxide is supported. The term “other titanium oxides” refers to an anatase-type, brookite-type, or rutile-type titanium oxide and a compound represented by TiₙO₂ₙ₋₁ (n represents an integer of 2 or 5 to 9). As shown in FIG. 8, generally, titanium oxides of different structures have different peak positions in X-ray diffraction measurement patterns. Thus, with the use of such properties, it is possible to determine the presence of Ti₄O₇ and the absence of other titanium oxides (i.e., the crystal phase is single-phase Ti₄O₇). In the present invention, the following method is used for determination.

When the XRD measurement data contains a large amount of noise as a whole, smoothing or background removal may be performed, before performing the following determination, using analysis software attached to the XRD system (e.g., X-ray powder diffraction pattern comprehensive analysis software “JADE7J” attached to an X-ray diffractometer (RINT-TTR3) available from Rigaku Corporation).

<Ti₄O₇>

When peaks are located at 26.0 to 26.6° and 20.4 to 21.0° in the pattern, it is determined that Ti₄O₇ is present. Here, the ratio of the intensity of the maximum peak at 20.4 to 21.0° relative to the intensity of the maximum peak at 26.0 to 26.6° taken as 100 is preferably more than 10, more preferably more than 20.

<TiₙO₂ₙ₋₁ (n Represents an Integer of 5 to 9) and Rutile Type Titanium Oxide>

When the ratio of the intensity at 27.7° relative to the intensity of the maximum peak at 26.0 to 26.6° taken as 100 is 15 or less in the pattern, the peak cannot be distinguished from peaks of other titanium oxides or noise so that it is determined that TiₙO₂ₙ₋₁ (n represents an integer of 5 to 9) and rutile type titanium oxide are absent.

<Anatase-Type and Brookite-Type Titanium Oxide>

When the ratio of the intensity of the maximum peak at 25.0 to 25.6° relative to the intensity of the maximum peak at 26.0 to 26.6° taken as 100 is 15 or less in the pattern, the peak cannot be distinguished from peaks of other titanium oxides or noise so that it is determined that anatase-type and brookite-type titanium oxides are absent.

<Ti₂O₃>

When the ratio of the intensity of the maximum peak at 23.5 to 24.1° relative to the intensity of the maximum peak at 26.0 to 26.6° taken as 100 is 15 or less in the pattern, the peak cannot be distinguished from peaks of other titanium oxides or noise so that it is determined that Ti₂O₃ is absent.

The titanium suboxide carrier has a specific surface area of 10 m²/g or more. When a titanium suboxide carrier has a specific surface area in the above range, the resulting electrode material is considered to be suitable for practical uses. Yet, the electrode material of the present invention has a specific surface area of more than 10 m²/g, considering the fact that a noble metal (such as platinum) and/or its oxide is supported on the carrier. In addition, such an electrode material is also suitable for automobile fuel cell applications which require electrodes capable of withstanding large load fluctuations. The specific surface area is preferably 13 m²/g or more, more preferably 16 m²/g or more. When the titanium suboxide carrier has a specific surface area in the above range, the titanium suboxide carrier has a suitable primary particle size to carry a noble metal (such as platinum) and/or its oxide thereon. The range of a preferred specific surface area of the resulting electrode material is the same.

Herein, the specific surface area (also referred to as “SSA”) is the BET specific surface area.

The BET specific surface area refers to the specific surface area obtained by the BET method which is one of methods for measuring the specific surface area. The specific surface area refers to the surface area per unit mass of an object.

The BET method is a gas adsorption method in which gas particles such as nitrogen are adsorbed onto solid particles, and the specific surface area is measured from the adsorbed amount. Herein, the specific surface area can be determined by a method in an example (described later).

The average primary particle size of the titanium suboxide carrier is preferably 20 to 200 nm. With the average primary particle size in this range, the resulting electrode material has better electrochemical properties. The resulting electrode material has higher conductivity because the resistance at the boundary of particles is sufficiently reduced. The average primary particle size is more preferably 30 to 150 nm.

The average primary particle size of the titanium suboxide carrier can be determined by a method similar to the later-described method for determining the average primary particle size of the noble metal (such as platinum) and/or its oxide.

In the electrode material of the present invention, any noble metal may be supported on the titanium suboxide carrier, but the noble metal is preferably at least one metal selected from the group consisting of platinum, ruthenium, iridium, rhodium, and palladium, in view of easy and stable catalytic reaction of the resulting electrode. In particular, platinum is more preferred. Because the noble metal is supported, the specific surface area of the electrode material is larger than that of the titanium suboxide carrier.

The noble metal and/or its oxide preferably has an average primary particle size of 1 to 20 nm. This allows the effects of the present invention, i.e., high conductivity and excellent electrochemical properties, to be further demonstrated. A preferred average particle size of the noble metal and/or its oxide varies depending on the design concept of a fuel cell. For example, the average particle size is more preferably 1 to 5 nm to achieve high current density, and is more preferably 5 to 20 nm to emphasize the electrode durability.

The average primary particle size of the noble metal can be determined by a method described in an example (described later).

Since a noble metal and/or its oxide is preferably supported on the titanium suboxide carrier, the average primary particle size of the noble metal and/or its oxide is preferably 30% or less of the average primary particle size of the titanium suboxide carrier.

Assuming that the amount of titanium suboxide carrier is 100 parts by weight, the supported amount of the noble metal and/or its oxide is preferably 0.01 to 30 parts by weight in terms of the noble metal element (when two or more kinds are used, the total supported amount is preferably in the above range). This allows the noble metal and/or its oxide to be more finely dispersed, thus further improving the performance of the electrode material. The supported amount is more preferably 0.1 to 20 parts by weight, still more preferably 1 to 15 parts by weight.

The noble metal forms an alloy depending on production conditions described later. The platinum particles may partially or entirely form an alloy with titanium for possible further improvement in conductivity and electrochemical properties.

In addition to the noble metal and/or its oxide, the electrode material may further contain at least one metal selected from the group consisting of nickel, cobalt, iron, copper, and manganese.

The electrode material of the present invention has excellent resistance to a high potential and strongly acidic environment, high conductivity equal to or higher than that of a conventional material containing platinum supported on a carbon carrier, and excellent electrochemical properties. Thus, the electrode material can be suitably used as an electrode material of fuel cells, solar cells, transistors, and display devices such as liquid crystal display panels. In particular, the electrode material is suitable as an electrode material of polymer electrolyte fuel cells (PEFCs). The embodiment in which the electrode material is an electrode material of a polymer electrolyte fuel cell as described above is one of preferred embodiments of the present invention. The present invention encompasses a fuel cell including an electrode including the electrode material.

### 2. Method for Producing Electrode Material

The electrode material of the present invention can be simply and easily obtained by a production method including: step (1) of obtaining a titanium suboxide carrier whose crystal phase is single-phase Ti₄O₇ and having a specific surface area of 10 m²/g or more; and step (2) of allowing a noble metal and/or its oxide to be supported on the carrier using a mixture containing the titanium suboxide carrier obtained in step (1) and the noble metal and/or its water-soluble compound. This production method may further include, as needed, one or more other steps that are included during the usual powder production.

Each step is further described below.

### 1) Step (1)

Step (1) is a step of obtaining a titanium suboxide carrier having a specific surface area of 10 m²/g or more and whose crystal phase is single-phase Ti₄O₇. Such Ti₄O₇ having a specific surface area in the above range and whose crystal phase is a single phase is used to carry a noble metal and/or its oxide (step (2)), whereby it is possible to provide an electrode material having excellent resistance to a high potential and strongly acidic environment, high conductivity, and excellent electrochemical properties. The specific surface area of the titanium suboxide carrier is preferably 13 m²/g or more, more preferably 16 m²/g or more.

Step (1) is not particularly limited as long as it is a step capable of providing the titanium suboxide carrier, but it is preferably a step of firing a raw material mixture containing titanium oxide and/or titanium hydroxide under a reducing atmosphere. Use of titanium oxide and/or titanium hydroxide results in fewer impurities that may enter during the production of the electrode material, and titanium oxide and titanium hydroxide are easily available, so that they are excellent in terms of stable supply. In particular, use of rutile type titanium oxide is preferred. This allows the titanium suboxide carrier whose crystal phase is single-phase Ti₄O₇ to be more efficiently obtained. It is more preferred to use rutile type titanium oxide having a specific surface area of 20 m²/g or more. This allows the titanium suboxide carrier having a large specific surface area and whose crystal phase is single-phase Ti₄O₇ to be more efficiently obtained. It is still more preferred to use rutile type titanium oxide having a specific surface area of 50 m²/g or more.

The raw material mixture may contain a reduction aid. Examples of the reduction aid include titanium metal, titanium hydride, and sodium borohydride. In particular titanium metal and titanium hydride are preferred. Titanium metal and titanium hydride may be used in combination.

The titanium suboxide carrier whose crystal phase is single-phase Ti₄O₇ can be more efficiently obtained by firing the raw material mixture further containing titanium metal. The titanium metal content is preferably 5 to 50 parts by weight relative to 100 parts by weight of titanium oxide and/or titanium hydroxide (the total amount when two or more kinds are used). The titanium metal content is more preferably 10 to 40 parts by weight.

The raw material mixture may also contain any other components as long as the effects of the present invention are not impaired. Examples of any other components include compounds containing elements in Group 1 to Group 15 of the periodic table. In particular, a compound containing at least one metal selected from the group consisting of nickel, cobalt, iron, copper, and manganese is preferred, for example. Preferred specific examples include oxides, hydroxides, chlorides, carbonates, sulfates, nitrates, and nitrites of these elements.

The raw material mixture can be obtained by mixing the above-described components by a usual mixing method, preferably by a dry method. In other words, the raw material mixture is preferably a dry mixture. This allows the titanium suboxide carrier whose crystal phase is single-phase Ti₄O₇ to be more efficiently obtained. The raw material mixture is particularly preferably a dry mixture containing rutile type titanium oxide and titanium metal.

Each raw material may be of one kind or two or more kinds.

The raw material mixture is fired under a reducing atmosphere. At that time, the raw material mixture may be fired directly, or the raw material mixture may be desolvated when containing a solvent, and then fired.

The reducing atmosphere is not particularly limited. Examples include hydrogen (H₂) atmosphere, carbon monoxide (CO) atmosphere, ammonia (NH₃) atmosphere, and a mixed gas atmosphere of hydrogen and inert gas. In particular, a hydrogen atmosphere is preferred because the titanium suboxide carrier can be efficiently produced. The hydrogen atmosphere may contain carbon monoxide or ammonia. Thus, step (1) is particularly preferably a step of firing a dry mixture containing rutile type titanium oxide (preferably, rutile type titanium oxide having a specific surface area in a predetermined range as described above) and titanium metal under a hydrogen atmosphere.

The firing may be performed only once or twice or more. When the firing is performed twice or more, the firing is preferably performed under a reducing atmosphere (preferably, a hydrogen atmosphere) each time.

The firing temperature depends on conditions of a reducing atmosphere such as hydrogen concentration, but is preferably 500° C. to 1100° C., for example. This allows the resulting electrode material to have a better balance of large specific surface area and high conductivity. The lower limit of the firing temperature is more preferably 600° C. or higher, still more preferably 650° C. or higher. The upper limit thereof is more preferably 1050° C. or lower, still more preferably 900° C. or lower, particularly preferably 850° C. or lower.

Herein, the firing temperature means the highest temperature reached in the firing step.

The firing time, i.e., the retention time at the firing temperature also depends on conditions of a reducing atmosphere such as hydrogen concentration, but it is preferably 5 minutes to 100 hours, for example. When the firing time is in the above range, the reaction proceeds more sufficiently, resulting in excellent productivity. The firing time is more preferably 30 minutes to 24 hours, still more preferably 60 minutes to 10 hours, particularly preferably 2 to 10 hours. When the atmosphere is cooled after the completion of firing, the atmosphere may be mixed or replaced with a gas other than hydrogen (e.g., nitrogen gas).

### 2) Step (2)

Step (2) is a step of allowing a noble metal and/or its oxide to be supported on the titanium suboxide carrier using a mixture containing the titanium suboxide carrier obtained in step (1) and the noble metal and/or its water-soluble compound (hereinafter also collectively referred to as a “noble metal compound”). The method may include one or more other steps such as crushing, washing with water, and classification, as needed, between step (1) and step (2). Other steps are not particularly limited.

The mixture contains the titanium suboxide carrier obtained in step (1) and a noble metal compound. The mixture is preferably obtained by mixing a slurry containing the titanium suboxide carrier obtained in step (1) and a solution of a noble metal compound, for example. Use of the mixture allows the noble metal and/or its oxide to be supported in a more highly dispersed state.

Each component of the mixture may be of one kind or two or more kinds.

The method for obtaining the mixture, i.e., the method for mixing the components, is not particularly limited. For example, a solution of a noble metal compound is added to a slurry containing the titanium suboxide carrier while the slurry is stirred in a container, followed by mixing under stirring. The temperature at the time of addition is preferably 40° C. or lower. The mixture is preferably heated to a predetermined temperature while being stirred. The mixture may be stirred using a stirrer with a stir bar, or using a stirring device provided with a propeller type or paddle type stirring blades.

The slurry further contains a solvent.

The solvent may be of any type such as water, an acidic solvent, an organic solvent, or a mixture thereof. Examples of the organic solvent include alcohol, acetone, dimethylsulfoxide, dimethylformamide, tetrahydrofuran, and dioxane. Examples of the alcohol include water-soluble monohydric alcohols such as methanol, ethanol, and propanol; and water-soluble diols or polyols such as ethylene glycol and glycerol. The solvent is preferably water, and more preferably ion-exchanged water.

The solvent content is not particularly limited. For example, the solvent content is preferably 100 to 100000 parts by weight relative to 100 parts by weight of the solids content of the titanium suboxide carrier obtained in step (1) (the total solids content when two or more kinds are used). This allows the electrode material to be more simply obtained. The solvent content is more preferably 500 to 50000 parts by weight, still more preferably 1000 to 30000 parts by weight.

The slurry may also contain additives such as acid, alkali, chelate compounds, organic dispersants, and polymer dispersants. These additives are expected to improve the dispersibility of the titanium suboxide carrier contained in the slurry.

The solution of the noble metal compound is not particularly limited as long as it contains a noble metal compound (i.e., a noble metal and/or its water-soluble compound). Examples include solutions of inorganic salts (e.g., sulfate, nitrate, chloride, and phosphate) of a noble metal; solutions of organic acid salts (e.g., acetate and oxalate) of a noble metal; and dispersions of nano-sized noble metals. In particular, solutions such as a chloride solution, a nitrate solution, a dinitrodiammine nitric acid solution, and a bis(acetylacetonato)platinum(II) solution are preferred. The noble metal is as described above, and platinum is particularly preferred. Thus, the solution of the noble metal is particularly preferably an aqueous chloroplatinic acid solution or an aqueous dinitrodiammine platinum nitric acid solution, and most preferably an aqueous chloroplatinic acid solution in terms of reactivity.

The used amount of the solution of the noble metal is not particularly limited. For example, the used amount in terms of the noble metal element is preferably 0.01 to 50 parts by weight relative to 100 parts by weight of the total solids content of the titanium suboxide carrier. This allows the noble metal and/or its oxide to be more finely dispersed. The used amount is more preferably 0.1 to 40 parts by weight, still more preferably 10 to 30 parts by weight.

In step (2), the mixture may be reduced, surface-treated, and/or neutralized, as needed. For example, for reduction, the mixture is preferably mixed with a reducing agent to adequately reduce the noble metal compound. For surface treatment, the mixture is preferably mixed with a surfactant to optimize surfaces of the titanium suboxide carrier and the noble metal compound. For neutralization, the mixture is preferably mixed with a basic solution. When two or more of reduction, surface treatment, and neutralization are performed, the reducing agent, the surfactant, and the basic solution may be added separately in any order or may be added together.

Any reducing agent may be used. Examples include hydrazine chloride, hydrazine, sodium borohydride, alcohol, hydrogen, sodium thiosulfate, citric acid, sodium citrate, L-ascorbic acid, formaldehyde, ethylene, and carbon monoxide, with hydrazine chloride being preferred. The added amount is not particularly limited, but it is preferably 0.1 to 1 times the molar equivalent of the noble metal contained in the mixture.

The surfactant may be an anionic surfactant, a cationic surfactant, an amphoteric surfactant, or a nonionic surfactant, for example. Any of these may be used. For example, examples of the anionic surfactant include carboxylate anionic surfactants such as soap, sulfonate anionic surfactants such as sodium lauryl sulfate, and sulfate anionic surfactants such as lauryl sulfate sodium salt. Examples of the cationic surfactant include quaternary ammonium salt cationic surfactants such as polydimethyldiallylammonium chloride and amine salt cationic surfactants such as dihydroxyethylstearylamine. Examples of the amphoteric surfactant include amino acid amphoteric surfactants such as methyl laurylaminopropionate and betaine amphoteric surfactants such as lauryl dimethyl betaine. Examples of the nonionic surfactant include polyethylene glycol nonionic surfactants such as polyethylene glycol nonylphenyl ether, polyvinyl alcohol, and polyvinylpyrrolidone. The added amount is not particularly limited, but it is preferably 0.01 to 10 parts by weight, more preferably 0.1 to 5.0 parts by weight, relative to the total 100 parts by weight of the titanium suboxide carrier.

The basic solution is not particularly limited. Examples include an aqueous NaOH solution, an aqueous NH₃ solution, and an aqueous sodium carbonate solution, with an aqueous NaOH solution being preferred. The neutralization temperature during neutralization is preferably 60° C. to 100° C., more preferably 70° C. to 100° C.

In step (2), moisture and by-products are preferably removed from the mixture (which may be reduced, surface-treated, and/or neutralized as needed, as described above). Any removing means may be used, but removal of moisture and by-products by filtration, washing with water, drying, or evaporation under heating, for example, is preferred.

The by-products are preferably removed by washing with water. Residual by-products in the electrode material may dissolve into a system during operation of a polymer electrolyte fuel cell, for example, which may result in poor power generation characteristics or system damage. The method for washing with water is not particularly limited as long as it is a method capable of removing a water-soluble substance not supported on the titanium suboxide carrier from the system. Examples include filtration, washing with water, and decantation. Here, by-products are preferably removed by washing with water until the conductivity of the washing water is 10 μS/cm or less. More preferably, by-products are removed by washing with water until the conductivity is 3 μS/cm or less.

Also in step (2), it is more preferred to fire a powder of the mixture after moisture and by-products are removed from the mixture. This allows a noble metal or its oxide having a low degree of crystallinity not suitable for exertion of electrochemical properties to have a degree of crystallinity suitable for exertion of electrochemical properties. The degree of crystallinity is considered to be sufficient if peaks derived from a noble metal or its oxide can be observed in XRD. When a dried powder is fired, it is preferably fired under a reducing atmosphere. The reducing atmosphere is as described above. A hydrogen atmosphere is particularly preferred. The firing temperature is not particularly limited, but it is preferably 500° C. to 900° C., for example. The firing time is also not particularly limited, but it is preferably 30 minutes to 24 hours, for example. This allows a noble metal or its oxide to be bonded to the titanium suboxide carrier in a state suitable for exertion of electrochemical properties. The bonding state can be determined as suitable by XRD when a peak derived from a noble metal or its oxide is shifted to a higher angle side or a lower angle side when fired under a reducing atmosphere than when fired not under a reducing atmosphere. Preferably, the peak is shifted to a higher angle side.

Step (2) is particularly preferably a step of reducing a mixture containing the titanium suboxide carrier obtained in step (1) and a noble metal compound, filtering and drying the reduced mixture to obtain a powder, and firing the powder.

### 3. Fuel Cell

The electrode material of the present invention and an electrode material obtained by the production method of the present invention can be suitably used for electrode materials of fuel cells. In particular, these electrode materials are suitable as electrode materials of polymer electrolyte fuel cells (PEFC). These electrode materials are particularly useful as alternatives to a conventional material containing platinum supported on a carbon carrier. Such electrode materials are suitable either as positive electrodes (also referred to as “air electrodes”) or negative electrodes (also referred to as “fuel electrodes”), and are also suitable either as cathodes (positive electrode) or anodes (negative electrodes). A polymer electrolyte fuel cell including the electrode material of the present invention or an electrode material obtained by the production method of the present invention is one of preferred embodiments of the present invention.

### EXAMPLES

Specific examples are provided below to describe the present invention in detail, but the present invention is not limited to these examples. The “%” means “% by weight (% by mass)” unless otherwise specified.

### Example 1

First, 2.0 g of rutile type titanium oxide (Sakai Chemical Industry Co., Ltd., product name “STR-100N”, specific surface area of 100 m²/g) was dry-mixed with 0.3 g of titanium metal (Wako Pure Chemical Industries, Ltd., product name “titanium, powder”). Then, the mixture was heated to 700° C. over 70 minutes under a hydrogen atmosphere, and the temperature was maintained at 700° C. for 6 hours, followed by cooling to room temperature. Thus, a titanium suboxide carrier whose crystal phase was represented by Ti₄O₇ was obtained. Then, 0.7 g of the titanium suboxide carrier and 114 g of ion-exchanged water were weighed into a beaker, and mixed under stirring. Thus, a titanium suboxide carrier slurry was obtained.

In a separate beaker, 0.57 g of an aqueous chloroplatinic acid solution (15.343% based on platinum, Tanaka Kikinzoku Kogyo) was diluted with 3.4 g of ion-exchanged water. Then, 0.024 g of hydrazine chloride (Tokyo Chemical Industry Co., Ltd., product name “Hydrazine Dihydrochloride”) was added to the diluted solution, followed by mixing under stirring (the resulting product is referred to as a “mixed aqueous solution”).

While the titanium suboxide carrier slurry was stirred, 4.0 g of the mixed aqueous solution prepared in the separate beaker was added thereto, followed by mixing under stirring with the mixture heated to and maintained at a liquid temperature of 70° C. Further, 10.0 g of a 0.1 N aqueous sodium hydroxide solution was added, followed by mixing under stirring. The mixture was heated to and maintained at a liquid temperature of 70° C. for 1 hour, followed by filtration, washing with water, drying to evaporate all the moisture according to a usual method. Thus, 0.7 g of a powder was obtained. Then, 0.5 g of the powder was heated to 550° C. under a hydrogen atmosphere, and the temperature was maintained at 550° C. for 1 hour, followed by cooling to room temperature. Thus, a powder 1 was obtained. An X-ray powder diffraction pattern of the powder 1 showed the presence of the titanium suboxide carrier, Pt, and Pt₃Ti as an alloy of titanium and platinum.

### Example 2

A titanium suboxide carrier slurry was obtained as in Example 1.

In a separate beaker, 0.9 g of an aqueous chloroplatinic acid solution (15.343% based on platinum, Tanaka Kikinzoku Kogyo) was diluted with 5.3 g of ion-exchanged water. Then, 0.037 g of hydrazine chloride (Tokyo Chemical Industry Co., Ltd., product name “Hydrazine Dihydrochloride”) was added to the diluted solution, followed by mixing under stirring (the resulting product is referred to as a “mixed aqueous solution”).

While the titanium suboxide carrier slurry was stirred, 6.2 g of the mixed aqueous solution prepared in the separate beaker was added thereto, followed by mixing under stirring with the mixture heated to and maintained at a liquid temperature of 70° C. Further, 16.0 g of a 0.1 N aqueous sodium hydroxide solution was added, followed by mixing under stirring. The mixture was heated to and maintained at a liquid temperature of 70° C. for 1 hour, followed by filtration, washing with water, drying to evaporate all the moisture according to a usual method. Thus, 0.7 g of a powder was obtained.

Then, 0.5 g of the powder was heated to 550° C. under a hydrogen atmosphere, and the temperature was maintained at 550° C. for 1 hour, followed by cooling to room temperature. Thus, a powder 2 was obtained. An X-ray powder diffraction pattern of the powder 2 showed the presence of the titanium suboxide carrier, Pt, and Pt₃Ti as an alloy of titanium and platinum.

### Comparative Example 1

First, 20.00 g of anatase-type titanium dioxide sol (Sakai Chemical Industry Co., Ltd., product name “CSB”, specific surface area of 280 m²/g) was stirred while being heated to and maintained at a liquid temperature of 80° C. to evaporate all the liquid. Thus, a powder A was obtained. Then, 5.0 g of the powder A was dry-mixed with 0.75 g of titanium metal ((Wako Pure Chemical Industries, Ltd., product name “titanium, powder”). Subsequently, the mixture was heated to 900° C. over 270 minutes under a hydrogen atmosphere, and the temperature was maintained at 900° C. for 10 hours, followed by cooling to room temperature. Thus, a titanium suboxide carrier whose crystal phase was represented by Ti₄O₇ was obtained. Then, 0.9 g of the titanium suboxide carrier and 40 g of ethanol were weighed into a beaker, and mixed under stirring. Thus, a titanium suboxide carrier slurry was obtained.

While the titanium suboxide carrier slurry was stirred, 0.14 g of bis(acetylacetonato)platinum(II) (N.E. Chemcat Corporation, 49.5% based on platinum) was added thereto, followed by stirring with the mixture heated to and maintained at a liquid temperature of 60° C. to evaporate all the liquid. Thus, a powder 3 was obtained.

### Comparative Example 2

First, 1.8 g of the titanium suboxide carrier obtained in Comparative Example 1, 0.2 g of anatase-type titanium dioxide (Sakai Chemical Industry Co., Ltd., product name “SSP-25”, specific surface area of 270 m²/g), and 114 g of ion-exchanged water were weighed into a beaker, followed by mixing under stirring. Thus, a slurry containing the titanium suboxide carrier and titanium oxide was obtained. Then, a powder 4 was obtained as in Example 2, except that the slurry containing the titanium suboxide carrier and titanium oxide was used.

### Comparative Example 3

First, 2.0 g of rutile type titanium oxide (Sakai Chemical Industry Co., Ltd., product name “STR-100N”, specific surface area of 100 m²/g) and 0.3 g of titanium metal ((Wako Pure Chemical Industries, Ltd., product name “titanium, powder”) were dry-mixed. Subsequently, the mixture was heated to 700° C. over 70 minutes under a hydrogen atmosphere, and the temperature was maintained at 700° C. for 1 hour, followed by cooling to room temperature. Thus, a titanium suboxide carrier as a multiphase of Ti₄O₇ and TiₙO₂ₙ₋₁ (n represents an integer of 5 to 9) was obtained. Then, a powder 5 was obtained as in Example 2 except that the titanium suboxide carrier was used.

### Comparative Example 4

First, 2.0 g of rutile type titanium oxide (Sakai Chemical Industry Co., Ltd., product name “STR-100N”, specific surface area of 100 m²/g) and 0.6 g of titanium metal ((Wako Pure Chemical Industries, Ltd., product name “titanium, powder”) were dry-mixed. Subsequently, the mixture was heated to 700° C. over 70 minutes under a hydrogen atmosphere, and the temperature was maintained at 700° C. for 1 hour, followed by cooling to room temperature. Thus, a titanium suboxide carrier as a multiphase of Ti₄O₇ and Ti₂O₃ was obtained. Then, a powder 6 was obtained as in Example 2, except that the titanium suboxide carrier was used.

### Comparative Example 5

First, 1.0 g of the titanium suboxide carrier obtained in Example 1, 0.5 g of anatase-type titanium dioxide (Sakai Chemical Industry Co., Ltd., product name “SSP-25”, specific surface area of 270 m²/g), and 114 g of ion-exchanged water were weighed into a beaker, followed by mixing under stirring. Thus, a slurry containing the titanium suboxide carrier and titanium oxide was obtained. Then, a powder 7 was obtained as in Example 1, except that the slurry containing the titanium suboxide carrier and titanium oxide was used.

### <Evaluation of Physical Properties>

Physical properties of each powder obtained were evaluated by procedures described below. The results are shown in Table 1 and figures.

### 1. Electrochemical Surface Area (ECSA)

### (1) Production of Working Electrode

Each sample to be measured was mixed with a 5% by weight perfluorosulfonic acid resin solution (Sigma-Aldrich), isopropyl alcohol (Wako Pure Chemical Industries, Ltd.), and ion-exchanged water, followed by ultrasonic dispersion. Thus, a paste was prepared. The paste was applied to a rotating glassy carbon disk electrode, and sufficiently dried. The dried rotating electrode was obtained as a working electrode.

### (2) Cyclic Voltammetry Measurement

A rotating electrode device (Hokuto Denko Corporation, product name “HR-301”) was connected to an automatic polarization system (Hokuto Denko Corporation, product name “HZ-5000”), and the electrode with a measurement sample was used as a working electrode. A counter electrode and a reference electrode were a platinum electrode and a reversible hydrogen electrode (RHE), respectively.

In order to clean the electrode with a measurement sample, while an electrolyte (0.1 mol/l aqueous perchloric acid solution) was bubbled with argon gas at 25° C., the electrode was subjected to cyclic voltammetry from 1.2 V to 0.05 V. Then, cyclic voltammetry was performed from 1.2 V to 0.05 V at a sweep rate of 50 mV/sec, using the electrolyte (0.1 mol/l aqueous perchloric acid solution) saturated with argon gas at 25° C.

Subsequently, the electrochemical surface area was calculated using the following mathematical formula (i) from the area of a hydrogen adsorption wave obtained with sweeping (charge of hydrogen adsorption: QH (μC)). The result was used as an indicator of electrochemical properties. In the mathematical formula (i), “210 (μCcm²)” is the adsorbed charge per unit active area of platinum (Pt).

[Math 1]

Active area of Pt catalyst per gram of Pt={−QH(μC)/210(μCcm²)×10⁴}×{1/weight (g) of Pt} (i)

### 2. X-Ray Diffraction Pattern

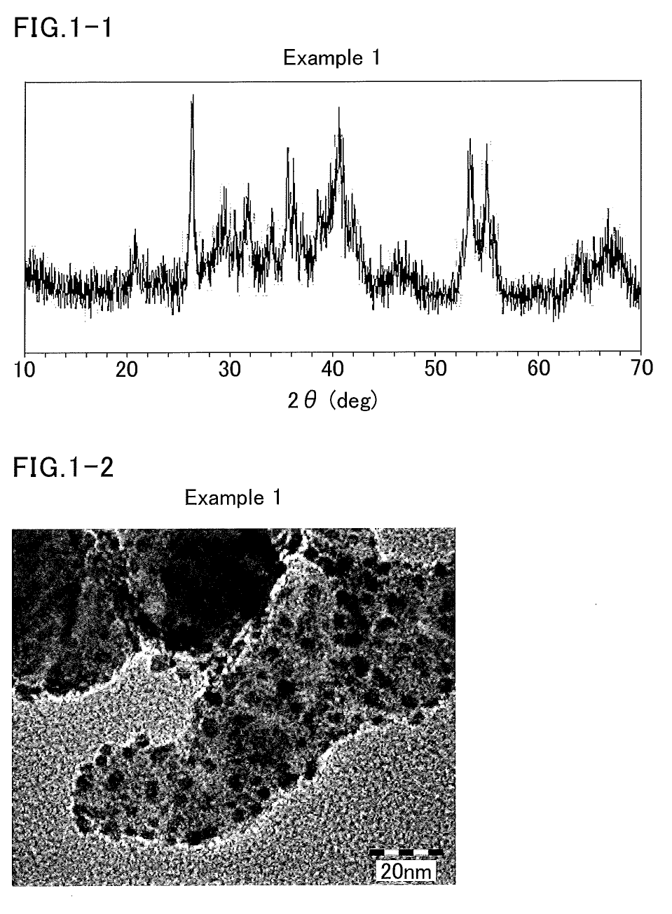

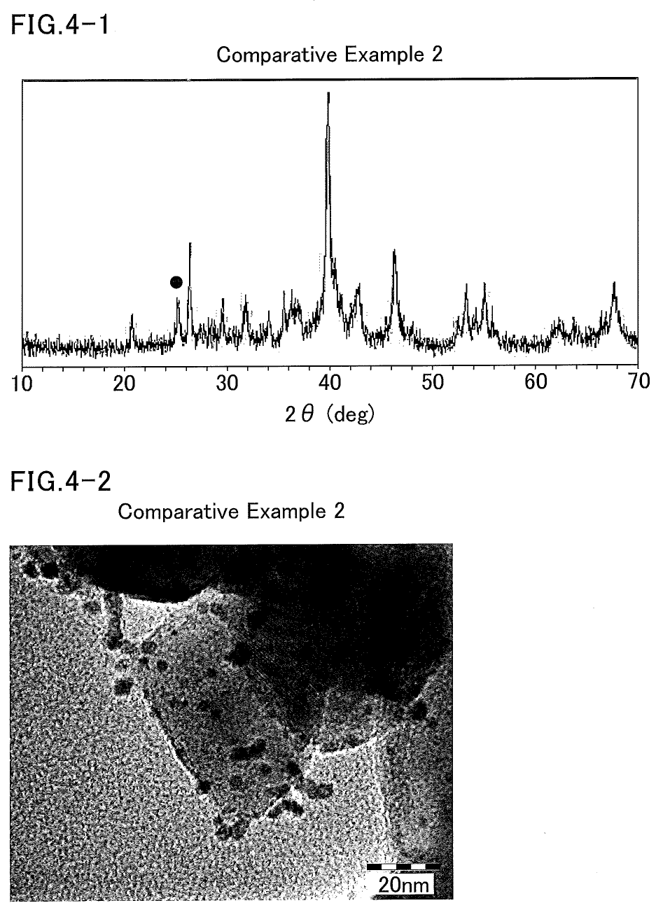

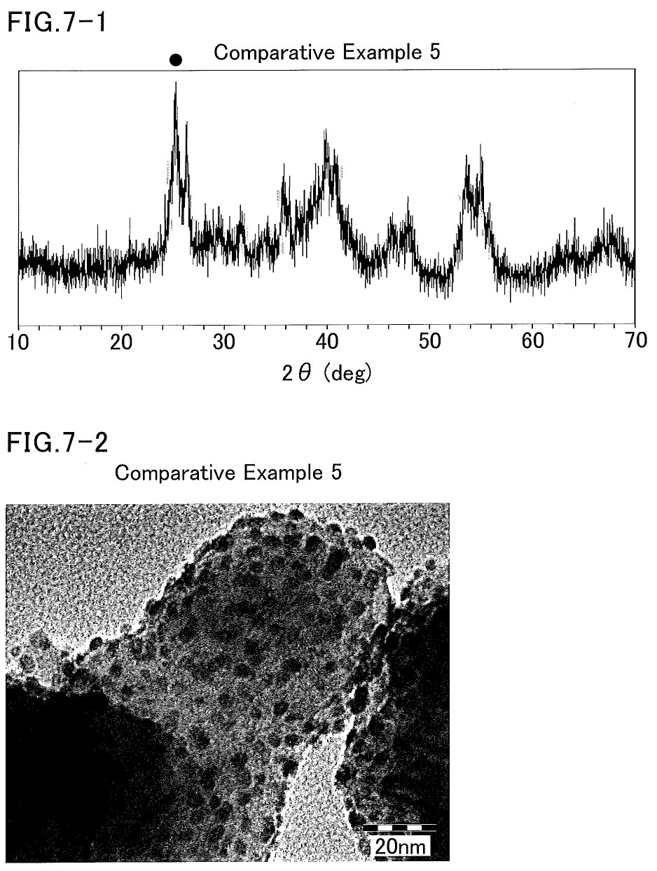

An X-ray powder diffraction pattern was measured using an X-ray diffractometer (Rigaku Corporation, product name “RINT-TTR3”) under the following conditions. The results are shown in FIGS. 1-1 to 7-1.

X-ray source: Cu-Kα
Measurement range: 2θ=10 to 70°
Scanning speed: 5°/min

### Voltage: 50 kV

### Current: 300 mA

### 3. Electron Micrograph Observation

A field emission transmission electron microscope “JEM-2100F” (JEOL Ltd.) was used for observation. The results are shown in FIGS. 1-2 to 7-2.

### 4. Supported Amount of Platinum

The platinum content in the sample was measured using a scanning X-ray fluorescence spectrometer ZSX Primus II (Rigaku Corporation), and the supported amount of platinum was calculated.

### 5. Average Primary Particle Size of Supported Platinum

First, in a transmission electron micrograph (also referred to as “TEM image” or “TEM photograph”), the long diameter and the short diameter of a platinum particle were measured using a ruler or the like, and an average of the long diameter and the short diameter was divided by the magnification ratio, whereby the primary particle size was determined. Further, 80 platinum particles in the TEM image were randomly selected, and the primary particle size was measured for each of the particles by the above method. The maximum measured value was regarded as the maximum primary particle size, and the minimum measured value was regarded as the minimum primary particle size. The measured values were averaged to determine an average primary particle size. The magnification ratio of the TEM image is not particularly limited, but it is preferably in the range of 20,000 times to 500,000 times.

### 6. Number of Platinum Particles Supported Per Gram of Catalyst (Sample)

The volume of supported platinum was calculated from the supported amount of platinum, and the volume of one platinum particle was determined from the average primary particle size of platinum. The volume of supported platinum was divided by the volume of one platinum particle to determine the number of platinum particles as an indicator of platinum dispersibility. Specifically, the following mathematical formula (ii) was used for calculation. The calculation was performed with the platinum density as 21.45 (g/cm³), pi as 3.14, and the platinum as a true sphere. The results are shown in Table 1.

$$\begin{matrix}[ Math 2 ] & \\ Number of Pt supported per gram of catalyst = \frac{\begin{matrix}Supported amount of Pt per gram of catalyst ( wt \% ) \times \\ 0.01 / density of Pt ( g / {cm}^{3} )\end{matrix}}{\begin{matrix}{( Average parimary particle size of Pt ( nm ) \times {10}^{- 7} / 2 )}^{3} \times \\ ( Pi ) \times 4 / 3\end{matrix}} & ( ii )\end{matrix}$$

### 7. Specific Surface Area (BET-SSA)

In accordance with JIS Z8830 (2013), the sample was heated at 200° C. for 60 minutes in a nitrogen atmosphere, and then the specific surface area (BET-SSA) was measured using a specific surface area meter (Mountech Co., Ltd., product name “Macsorb HM-1220”). The specific surface area of each carrier is shown in Table 1.

TABLE 1

| | | | | | | | | | After powder is | | Number |
|---|---|---|---|---|---|---|---|---|---|---|---|
| | | Physical properties of powder | | | | | Carrier | | supported (product) | | (pcs) of Pt |
| | | | Supported | Average primary particle | | | | Specific | | Specific | supported |
| | | | amount of | size of platinum (nm) | | | | surface | | surface | per |
| | Powder | ECSA | platinum | | | Mini- | | area | | area | gram of |
| | No. | (m²/g^{Pt}) | (wt %) | Average | Maximum | mum | Crystal phase | (m²/g) | Crystal phase | (m²/g) | catalyst |
| Example 1 | Powder 1 | 73.5 | 7.4 | 3.5 | 6.3 | 2 | Ti₄O₇ single phase | 16.5 | Ti₄O₇ single phase | 17.9 | 1.5 × 10¹⁷ |
| Example 2 | Powder 2 | 53.1 | 11.4 | 4.1 | 7.3 | 2 | Ti₄O₇ single phase | 16.5 | Ti₄O₇ single phase | 17.6 | 1.5 × 10¹⁷ |
| Comparative | Powder 3 | 1.3 | 7.0 | 73.7 | 110.7 | 28.6 | Ti₄O₇ single phase | 0.3 | Ti₄O₇ single phase | 0.4 | 1.6 × 10¹³ |
| Example 1 | | | | | | | | | | | |
| Comparative | Powder 4 | 4.7 | 11.4 | 7.0 | — | — | Multiphase of | 27.5 | Multiphase of | — | — |
| Example 2 | | | | | | | Ti₄O₇ and TiO₂ | | Ti₄O₇ and TiO₂ | | |
| Comparative | Powder 5 | 37.0 | 10.6 | 3.9 | — | — | Multiphase of | 19.3 | Multiphase of | — | — |
| Example 3 | | | | | | | Ti₄O₇ and TiₙO₂ₙ₋₁ | | Ti₄O₇ and TiₙO₂ₙ₋₁ | | |
| | | | | | | | (n is an integer | | (n is an integer | | |
| | | | | | | | of 5 to 9) | | of 5 to 9) | | |
| Comparative | Powder 6 | 35.5 | 12.5 | 4.3 | — | — | Multiphase of | 13.7 | Multiphase of | — | — |
| Example 4 | | | | | | | Ti₄O₇ and Ti₂O₃ | | Ti₄O₇ and Ti₂O₃ | | |
| Comparative | Powder 7 | 25.2 | 8.5 | 4.4 | — | — | Multiphase of | 101.0 | Multiphase of | — | — |
| Example 5 | | | | | | | Ti₄O₇ and TiO₂ | | Ti₄O₇ and TiO₂ | | |

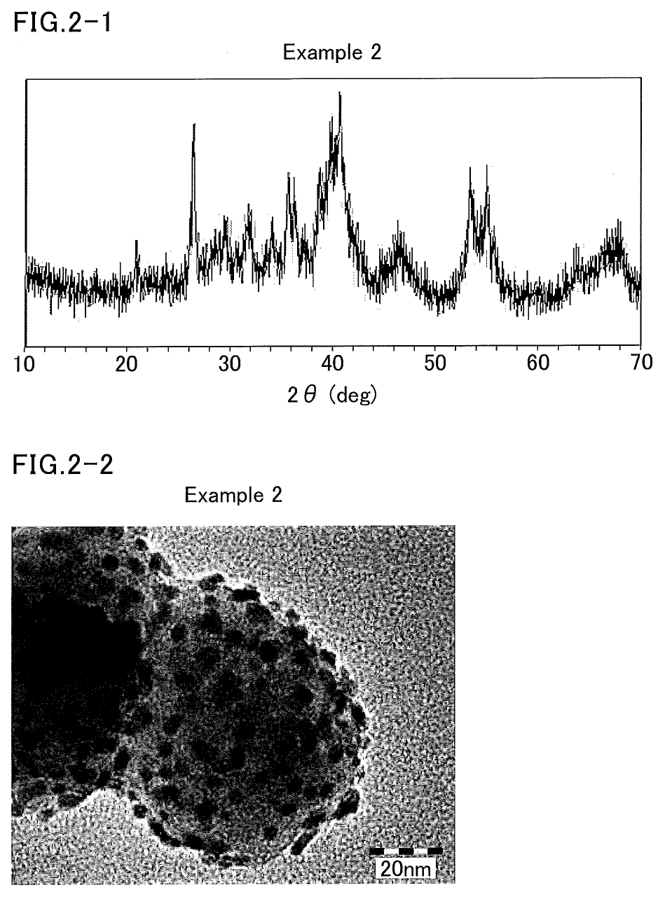

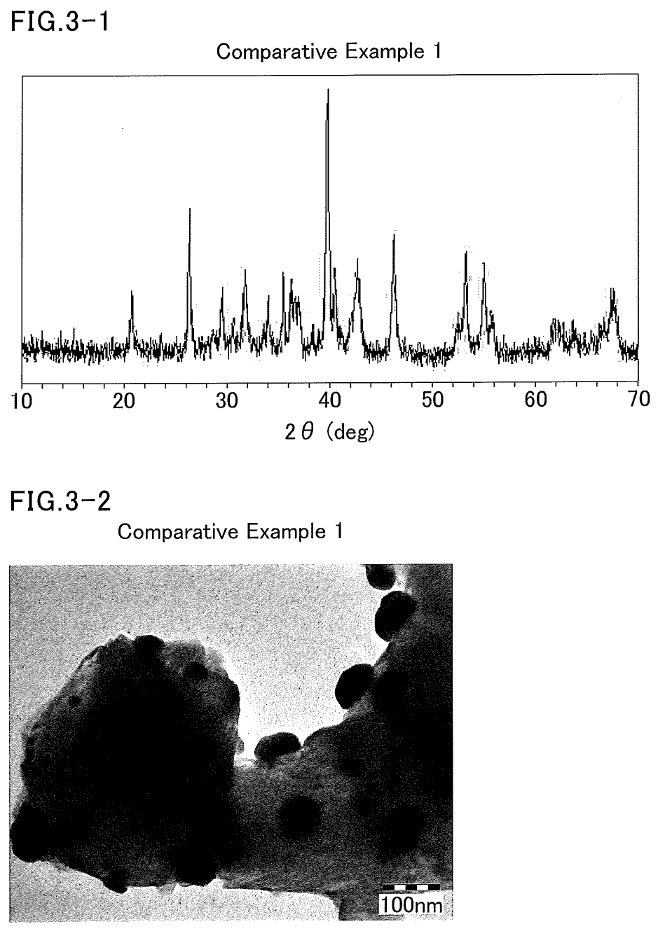

Here, in the X-ray diffraction measurement patterns of the powders obtained in Examples 1 and 2, peaks were present at 26.0 to 26.6° and 20.4 to 21.0° but no peaks were present at 23.5 to 24.1°, 25.0 to 25.6°, 27.7°, and 27.1 to 27.7° (the ratio of the intensity of the peak at each of these degrees relative to the intensity of the maximum peak at 26.0 to 26.6° taken as 100 was 15 or less). Thus, each of the powders obtained in Examples 1 and 2 was identified as a powder whose crystal phase was single-phase Ti₄O₇ (see FIGS. 1-1 and 2-1). The powder obtained in Comparative Example 1 was similarly identified as a powder whose crystal phase was single-phase Ti₄O₇ (see FIG. 3-1).

In contrast, in each of the powders obtained in Comparative Example 2 and Comparative Example 5, peaks were present not only at 26.0 to 26.6° and 20.4 to 21.0° but also at 25.0 to 25.6° (a peak derived from the anatase-type titanium dioxide, according to FIG. 8) (see black dots in FIG. 4-1 and FIG. 7-1). Thus, the crystal phase was identified as a multiphase of Ti₄O₇ and anatase-type titanium dioxide.

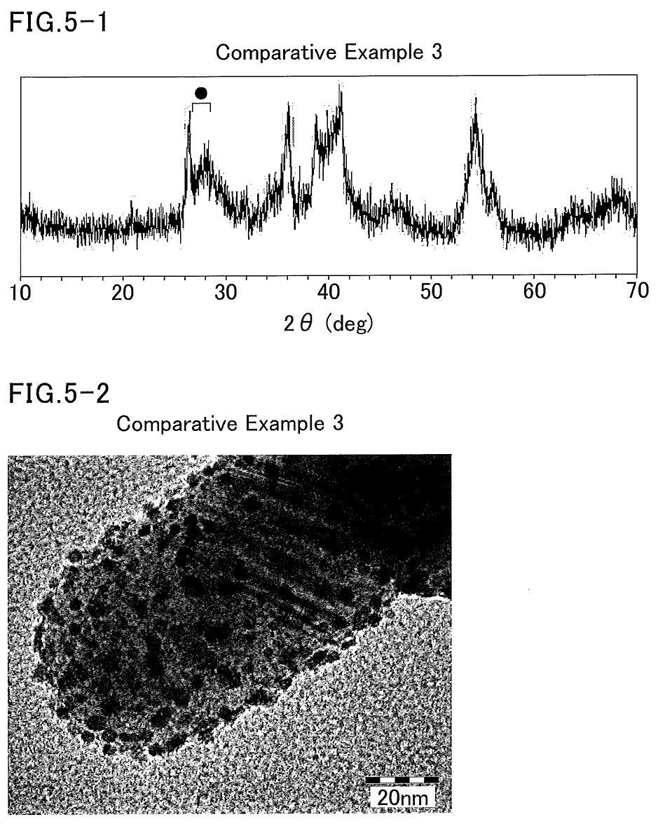

In the powder obtained in Comparative Example 3, peaks were present not only at 26.0 to 26.6° and 20.4 to 21.0° but also at 27.7° (a peak derived from TiₙO₂ₙ₋₁ (n represents an integer of 5 to 9), according to FIG. 8) (see a black dot in FIG. 5-1). Thus, the crystal phase was identified as a multiphase of Ti₄O₇ and TiₙO₂ₙ₋₁ (n represents an integer of 5 to 9).

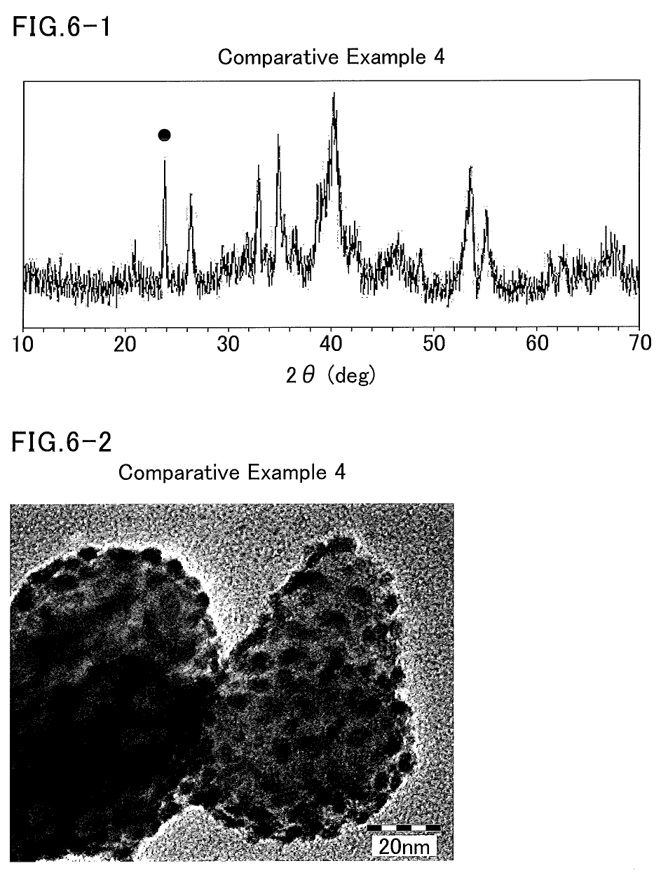

In the powder obtained in Comparative Example 4, peaks were present not only at 26.0 to 26.6° and 20.4 to 21.0° but also at 26.7 to 28.7° (a peak derived from Ti₂O₃, according to FIG. 8) (see a black dot in FIG. 6-1). Thus, the crystal phase was identified as a multiphase of Ti₄O₇ and Ti₂O₃.

The followings were confirmed based on the above results.

In each of the powders obtained in Examples 1 and 2, the crystal phase of the carrier is single-phase Ti₄O₇, and platinum is further supported on the carrier. In contrast, in each of the powders obtained in Comparative Examples 2 and 5, the crystal phase of the carrier is not single-phase Ti₄O₇ but is a multiphase of Ti₄O₇ and anatase-type titanium dioxide. Similarly, the powder obtained in Comparative Example 3 is a multiphase of Ti₄O₇ and TiₙO₂ₙ₋₁ (n represents an integer of 5 to 9), and the powder obtained in Comparative Example 4 is a multiphase of Ti₄O₇ and Ti₂O₃. A comparison of the ECSA serving as an indicator of electrochemical properties under these differences shows that the powders obtained in Examples 1 and 2 each exhibit a significantly high ECSA as compared to the powders obtained in Comparative Examples 2 to 4 (Table 1).

The powder obtained in Comparative Example 1 is a titanium suboxide carrier whose crystal phase is single-phase Ti₄O₇ as in the powders obtained in Examples 1 and 2. Yet, the powders obtained in Examples 1 and 2 are different from the powder obtained in Comparative Example 1 in that the carriers in Examples 1 and 2 each have a large specific surface area and the platinum particles are thus fine, as compared to Comparative Example 1. Further, because of a large number of supported platinum particles in addition to the observation results of the TEM images, the platinum particles of the powders of Examples 1 and 2 are assumed to be highly dispersed as compared to the platinum particles of the powder of Comparative Example 1. A comparison of the ECSA serving as an indicator of electrochemical properties under these differences shows that the powders obtained in Examples 1 and 2 each exhibit a significantly high ECSA as compared to the powder obtained in Comparative Example 1 (Table 1).

Here, a material having an ECSA of 40 m²/g^{Pt} or more is considered to exhibit electrochemical properties equivalent to those of a conventional material containing platinum having a particle size of about 4 nm supported on a carbon carrier. Thus, the powders obtained in Examples 1 and 2 are considered to have electrochemical properties equal to or higher than those of the material containing platinum supported on a carbon carrier.

Thus, it became clear that the electrode material of the present invention can provide high conductivity and excellent electrochemical properties, and that the production method of the present invention can simply and easily produce such an electrode material. The electrode material of the present invention also has very high resistance to a high potential and strongly acidic environment, as compared to conventionally used materials containing platinum supported on a carbon carrier. While electrode materials are usually used under high temperature and high humidity, the electrode material of the present invention is expected to maintain its performance even under high temperature and high humidity.

1. An electrode material comprising:
a titanium suboxide carrier whose crystal phase is single-phase Ti₄O₇ and having a specific surface area of 10 m²/g or more; and
a noble metal and/or its oxide supported on the carrier.

2. The electrode material according to claim 1,
wherein the noble metal is at least one metal selected from the group consisting of platinum, ruthenium, iridium, rhodium, and palladium, and has an average primary particle size of 1 to 20 nm.

3. The electrode material according to claim 1,
wherein the noble metal is platinum.

4. The electrode material according to claim 1,
which is an electrode material of a polymer electrolyte fuel cell.

5. A fuel cell comprising:
an electrode including the electrode material according to claim 1.

6. A method for producing the electrode material according to claim 1, the method comprising:
step (1) of obtaining a titanium suboxide carrier whose crystal phase is single-phase Ti₄O₇ and having a specific surface area of 10 m²/g or more; and
step (2) of allowing a noble metal and/or its oxide to be supported on the carrier using a mixture containing the titanium suboxide carrier obtained in step (1) and the noble metal and/or its water-soluble compound.

7. The method according to claim 6,
wherein step (1) is a step of firing a dry mixture containing rutile type titanium oxide having a specific surface area of 20 m²/g or more and titanium metal and/or titanium hydride under a hydrogen atmosphere.
